(19) United States
(12) Patent Application Publication
(10) Pub. No.: US 2026/0274471 A1
(43) Pub. Date: Sep. 17, 2026

(54) UAV Holding and Charging Structure

(71) Applicant: Wing Aviation LLC, Palo Alto, CA (US)

(72) Inventors: James Charles Schmalzried, San Jose, CA (US); André Peter Prager, Sunnyvale, CA (US); John Richard FitzSimons, JR., San Jose, CA (US); Matthew Aaron Nubbe, Santa Clara, CA (US); Kyle David Julian, Mountain View, CA (US); Dinuka Malin Wickramasinghe Abeywardena, Mountain View, CA (US); Jesse Hayden Blake, Palo Alto, CA (US); Benjamin Jerome Pelletier, Sunland, CA (US); Matthew N. Schneider, Sierra Madre, CA (US); James Ryan Burgess, Redwood City, CA (US)

(21) Appl. No.: 19/078,213

(22) Filed: Mar. 12, 2025

(51) Int. Cl. B64U 80/25; B64U 50/38; B64U 80/10; B64U 80/86

(52) U.S. Cl. CPC B64U 80/25; B64U 50/38; B64U 80/10; B64U 80/86

(57) ABSTRACT

A holding and charging system for uncrewed aerial vehicles (UAVs) includes a landing pad including a support surface for receiving a UAV, a first track extending from the landing pad, and a charging structure extending along the first track. The charging structure includes at least one electrical contact configured to provide electrical power to a UAV positioned on the first track.

### BACKGROUND

An uncrewed vehicle, which may also be referred to as an autonomous vehicle, is a vehicle capable of travel without a physically-present human operator. The term “unmanned” may sometimes be used instead of, or in addition to, “uncrewed,” and it should be understood that both terms have the same meaning, and may be used interchangeably. An uncrewed vehicle may operate in a remote-control mode, in an autonomous mode, or in a partially autonomous mode.

When an uncrewed vehicle operates in a remote-control mode, a pilot or driver that is at a remote location can control the uncrewed vehicle via commands that are sent to the uncrewed vehicle via a wireless link. When the uncrewed vehicle operates in autonomous mode, the uncrewed vehicle typically moves based on pre-programmed navigation waypoints, dynamic automation systems, or a combination of these. Further, some uncrewed vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of uncrewed vehicles exist for various different environments. For instance, uncrewed vehicles exist for operation in the air, on the ground, underwater, and in space. Examples include quad-copters and tail-sitter UAVs, among others. Uncrewed vehicles also exist for hybrid operations in which multi-environment operation is possible. Examples of hybrid uncrewed vehicles include an amphibious craft that is capable of operation on land as well as on water or a floatplane that is capable of landing on water as well as on land. Other examples are also possible.

### SUMMARY

The present embodiments are directed to systems for holding UAVs. The system may be used to safely store one or more UAVs between missions, and, in some examples, may also be utilized to charge the UAVs.

In one aspect a holding and charging system for a UAV is provided. The system comprises:
a landing pad including a support surface for receiving a UAV;
a first track extending from the landing pad; and
a charging structure extending along the first track, the charging structure including at least one electrical contact configured to provide electrical power to a UAV positioned on the first track.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1A is a simplified illustration of an uncrewed aerial vehicle, according to an example embodiment.

FIG. 1B is a simplified illustration of an uncrewed aerial vehicle, according to an example embodiment.

FIG. 1C is a simplified illustration of an uncrewed aerial vehicle, according to an example embodiment.

FIG. 1D is a simplified illustration of an uncrewed aerial vehicle, according to an example embodiment.

FIG. 1E is a simplified illustration of an uncrewed aerial vehicle, according to an example embodiment.

FIG. 2 is a simplified block diagram illustrating components of an uncrewed aerial vehicle, according to an example embodiment.

FIG. 3 is a simplified block diagram illustrating a UAV system, according to an example embodiment.

FIG. 4A is a perspective view showing an example UAV holding system with a UAV in a first position.

FIG. 4B is a perspective view of the UAV holding system of FIG. 4A with the UAV in a second position.

FIG. 4C is a perspective view of the UAV holding system of FIG. 4A with the UAV in a third position.

FIG. 4D is a perspective view of the UAV holding system of FIG. 4A with the UAV in a fourth position.

FIG. 5A is a side view of a portion of an example UAV.

FIG. 5B is a top perspective view of a portion of the UAV of FIG. 5A.

FIG. 5C is a detailed perspective view of a boom of the UAV of FIG. 5A.

FIG. 5D is a detailed front view of a boom of the UAV of FIG. 5A with a component secured in a track of a UAV holding system.

FIG. 5E is a detailed view of a component of the UAV of FIG. 5A and a section of a track of a UAV holding system.

FIG. 6 is a perspective view of an example UAV holding system.

FIG. 7A is a perspective view of another example UAV holding system integrated into a building.

FIG. 7B is a top view of the UAV holding system of FIG. 7A.

FIG. 8 is a perspective view of an example UAV holding system that includes a payload coupling apparatus.

FIG. 9 is a top view of a portion of an example UAV holding system with a track formed by two rails.

FIG. 10 is a top view of a portion of an example UAV holding system with a track formed by a single rail.

FIG. 11 is a top view of a portion of an example UAV holding system with two tracks.

FIG. 12 is a top view of a portion of an example UAV holding system with two tracks that share a common rail.

FIG. 13 is a top view of a portion of an example UAV holding system with two tracks that extend in opposite directions from a landing pad.

FIG. 14 is a side view of another example UAV holding system with two tracks that are spaced vertically.

FIG. 15 is a perspective view of another example UAV holding system including a roof.

FIG. 16 is a perspective view of another example UAV holding system including heating elements.

### DETAILED DESCRIPTION

Exemplary methods and systems are described herein. It should be understood that the word “exemplary” is used herein to mean “serving as an example, instance, or illustration.” Any implementation or feature described herein as “exemplary” or “illustrative” is not necessarily to be construed as preferred or advantageous over other implementations or features. In the figures, similar symbols typically identify similar components, unless context dictates otherwise. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

### I. Overview

In various industries, uncrewed aerial vehicles (UAVs) are increasingly being used in groups, or fleets, to perform tasks in an organized and coordinated manner. For example, UAVs may be used to provide deliveries in response to delivery requests, and using a group of UAVs allows the deliveries to be carried out in real time as the requests are received, even if multiple requests are simultaneous. Similarly, in surveillance or data collection operations, using a group of UAVs allows information to be gathered from various locations at the same time. These are just two examples of scenarios using multiple UAVs to perform tasks, there are various other uses for groups of UAVs.

In many scenarios, the effectiveness of a group of UAVs relies on the ability to deploy the UAVs quickly when needed and to maintain the batteries of the UAVs with sufficient charge for performing tasks. To meet these needs, the operators of UAV fleets may benefit from having sites for charging a number of UAVs concurrently and holding the UAVs in a manner that allows rapid deployment. Providing individual charging apparatuses from which each UAV can land, charge, and be deployed requires significant infrastructure and a large footprint.

Provided herein is a holding and charging system for UAVs. The system is configured to receive UAVs where they can be held until they are deployed on a new mission. If needed, while a UAV is held on the system, it may also be charged. In an example, the holding and charging system includes a landing pad and a track that extends from the landing pad that is long enough to accommodate multiple UAVs. In operation, a UAV may land on the landing pad and then navigate to the track. The system also includes a charging structure that extends along the track. Thus, when a UAV is on the track, it may be charged for future use. The UAV may move along the track to make room for other UAVs that subsequently land on the landing pad and move onto the track. When deployed on a new mission, the UAV leaves the track and carries out the mission.

In various examples, the holding and charging structure may be configured to also facilitate other operations. For instance, in some examples, the system may be configured to accommodate maintenance of UAVs, either by providing maintenance personnel with access to the UAVs while they are on the track, or by enabling easy removal of UAVs from the track that need maintenance. Further, in some examples, the structure may be configured to allow the UAVs to receive payloads while on the track. For example, the track may be elevated over one or more payload retrieval apparatuses from which the UAV may retrieve a payload while on the track.

Further details and various embodiments of holding and charging structures of UAVs are described in more detail below.

### II. Illustrative Uncrewed Vehicles

Herein, the terms “uncrewed aerial vehicle” and “UAV” refer to any autonomous or semi-autonomous vehicle that is capable of performing some functions without a physically present human pilot.

A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “uncrewed aerial vehicle system” (UAVS), or “uncrewed aerial system” (UAS) may also be used to refer to a UAV.

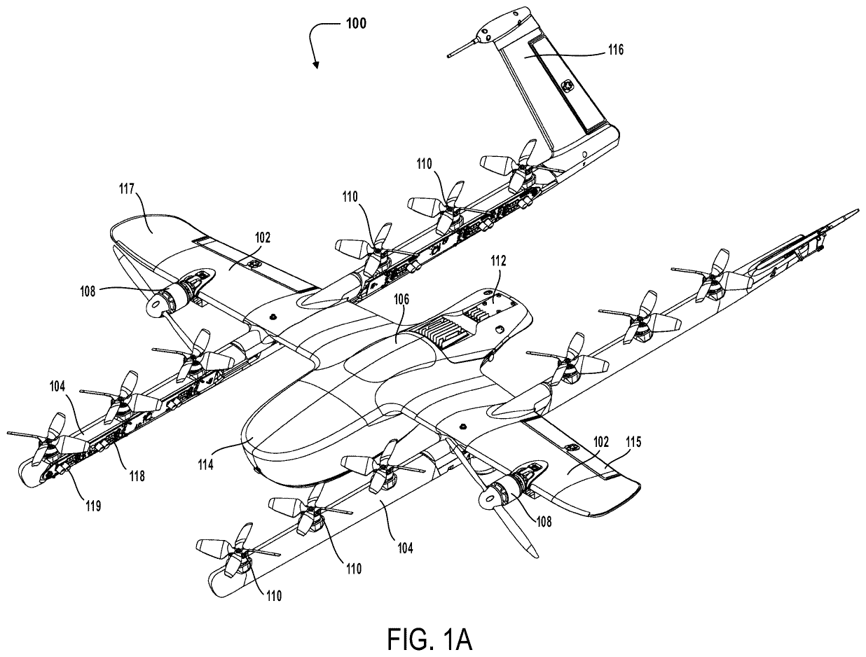

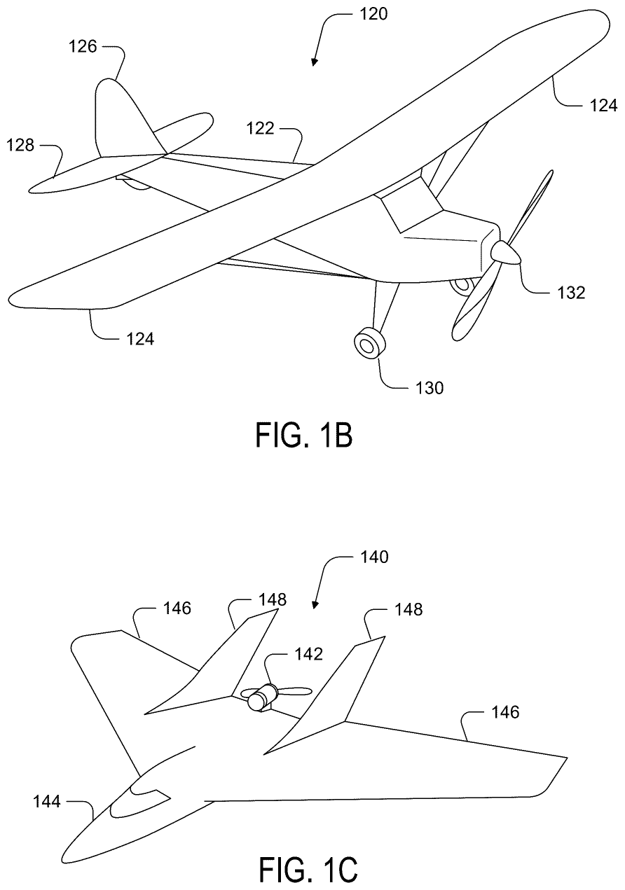

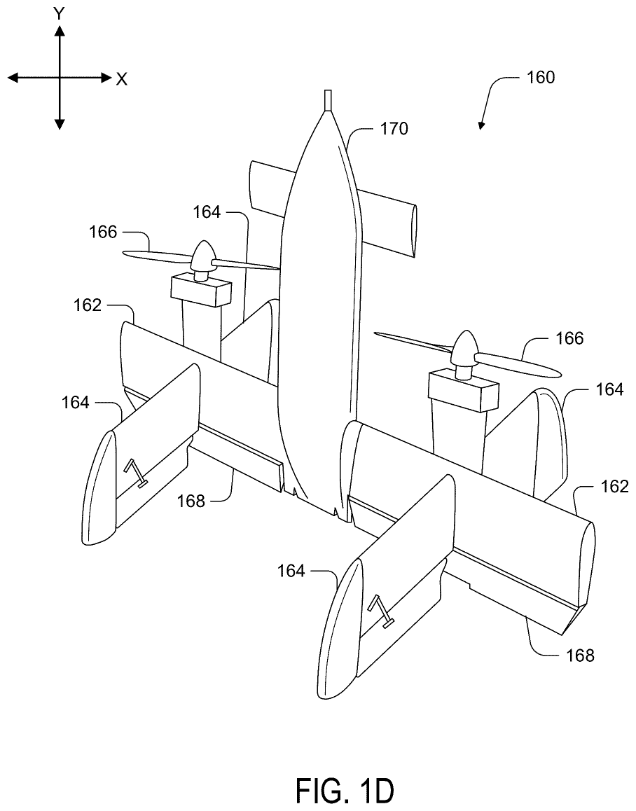

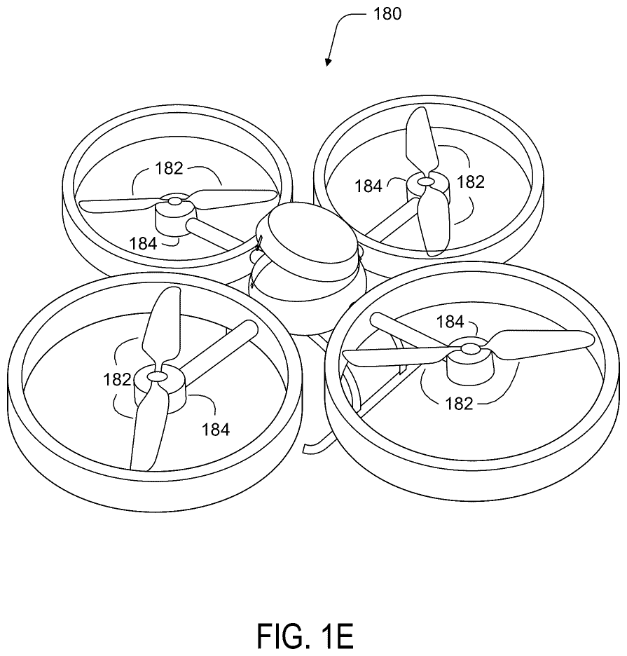

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1 illustrates two wings 102, two booms 104, two horizontal propulsion units 108, and six vertical propulsion units 110 per boom 104, it should be appreciated that other variants of UAV 100 may be implemented with more or less of these components. For example, UAV 100 may include four wings 102, four booms 104, and more or less propulsion units (horizontal or vertical).

Similarly, FIG. 1B shows another example of a fixed-wing UAV 120. The fixed-wing UAV 120 includes a fuselage 122, two wings 124 with an airfoil-shaped cross section to provide lift for the UAV 120, a vertical stabilizer 126 (or fin) to stabilize the plane's yaw (turn left or right), a horizontal stabilizer 128 (also referred to as an elevator or tailplane) to stabilize pitch (tilt up or down), landing gear 130, and a propulsion unit 132, which can include a motor, shaft, and propeller.

FIG. 1C shows an example of a UAV 140 with a propeller in a pusher configuration. The term “pusher” refers to the fact that a propulsion unit 142 is mounted at the back of the UAV and “pushes” the vehicle forward, in contrast to the propulsion unit being mounted at the front of the UAV. Similar to the description provided for FIGS. 1A and 1B, FIG. 1C depicts common structures used in a pusher plane, including a fuselage 144, two wings 146, vertical stabilizers 148, and the propulsion unit 142, which can include a motor, shaft, and propeller.

FIG. 1D shows an example of a tail-sitter UAV 160. In the illustrated example, the tail-sitter UAV 160 has fixed wings 162 to provide lift and allow the UAV 160 to glide horizontally (e.g., along the x-axis, in a position that is approximately perpendicular to the position shown in FIG. 1D). However, the fixed wings 162 also allow the tail-sitter UAV 160 to take off and land vertically on its own.

For example, at a launch site, the tail-sitter UAV 160 may be positioned vertically (as shown) with its fins 164 and/or wings 162 resting on the ground and stabilizing the UAV 160 in the vertical position. The tail-sitter UAV 160 may then take off by operating its propellers 166 to generate an upward thrust (e.g., a thrust that is generally along the y-axis). Once at a suitable altitude, the tail-sitter UAV 160 may use its flaps 168 to reorient itself in a horizontal position, such that its fuselage 170 is closer to being aligned with the x-axis than the y-axis. Positioned horizontally, the propellers 166 may provide forward thrust so that the tail-sitter UAV 160 can fly in a similar manner as a typical airplane.

Many variations on the illustrated fixed-wing UAVs are possible. For instance, fixed-wing UAVs may include more or fewer propellers, and/or may utilize a ducted fan or multiple ducted fans for propulsion. Further, UAVs with more wings (e.g., an “x-wing” configuration with four wings), with fewer wings, or even with no wings, are also possible.

As noted above, some embodiments may involve other types of UAVs, in addition to or in the alternative to fixed-wing UAVs. For instance, FIG. 1E shows an example of a rotorcraft that is commonly referred to as a multicopter 180. The multicopter 180 may also be referred to as a quadcopter, as it includes four rotors 182. It should be understood that example embodiments may involve a rotorcraft with more or fewer rotors than the multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to the multicopter 180 in greater detail, the four rotors 182 provide propulsion and maneuverability for the multicopter 180. More specifically, each rotor 182 includes blades that are attached to a motor 184. Configured as such, the rotors 182 may allow the multicopter 180 to take off and land vertically, to maneuver in any direction, and/or to hover. Further, the pitch of the blades may be adjusted as a group and/or differentially, and may allow the multicopter 180 to control its pitch, roll, yaw, and/or altitude.

It should be understood that references herein to an “uncrewed” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of uncrewed aerial vehicle.

### III. Illustrative UAV Components

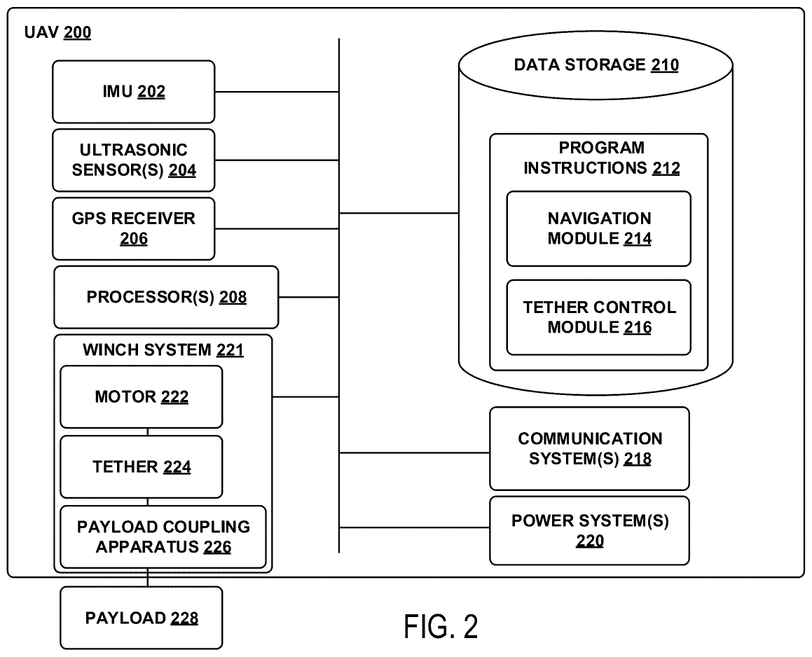

FIG. 2 is a simplified block diagram illustrating components of a UAV 200, according to an example embodiment. UAV 200 may take the form of, or be similar in form to, one of the UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include an inertial measurement unit (IMU) 202, ultrasonic sensor(s) 204, and a GPS 206, among other possible sensors and sensing systems.

In the illustrated embodiment, UAV 200 also includes one or more processors 208. A processor 208 may be a general-purpose processor or a special purpose processor (e.g., digital signal processors, application specific integrated circuits, etc.). The one or more processors 208 can be configured to execute computer-readable program instructions 212 that are stored in the data storage 210 and are executable to provide the functionality of a UAV described herein.

The data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of the one or more processors 208. In some embodiments, the data storage 210 can be implemented using a single physical device (e.g., one optical, magnetic, organic or other memory or disc storage unit), while in other embodiments, the data storage 210 can be implemented using two or more physical devices.

As noted, the data storage 210 can include computer-readable program instructions 212 and perhaps additional data, such as diagnostic data of the UAV 200. As such, the data storage 210 may include program instructions 212 to perform or facilitate some or all of the UAV functionality described herein. For instance, in the illustrated embodiment, program instructions 212 include a navigation module 214 and a tether control module 216.

### A. Sensors

In an illustrative embodiment, IMU 202 may include both an accelerometer and a gyroscope, which may be used together to determine an orientation of the UAV 200. In particular, the accelerometer can measure the orientation of the vehicle with respect to earth, while the gyroscope measures the rate of rotation around an axis. IMUs are commercially available in low-cost, low-power packages. For instance, an IMU 202 may take the form of or include a miniaturized MicroElectroMechanical System (MEMS) or a NanoElectroMechanical System (NEMS). Other types of IMUs may also be utilized.

An IMU 202 may include other sensors, in addition to accelerometers and gyroscopes, which may help to better determine position and/or help to increase autonomy of the UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of the UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for uncrewed vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with uncrewed vehicles. Such imaging sensor(s) have numerous possible applications, such as obstacle avoidance, localization techniques, ground tracking for more accurate navigation (e.g., by applying optical flow techniques to images), video feedback, and/or image recognition and processing, among other possibilities.

UAV 200 may also include a GPS receiver 206. The GPS receiver 206 may be configured to provide data that is typical of well-known GPS systems, such as the GPS coordinates of the UAV 200. Such GPS data may be utilized by the UAV 200 for various functions. As such, the UAV may use its GPS receiver 206 to help navigate to the caller's location, as indicated, at least in part, by the GPS coordinates provided by their mobile device. Other examples are also possible.

### B. Navigation and Location Determination

The navigation module 214 may provide functionality that allows the UAV 200 to, e.g., move about its environment and reach a desired location. To do so, the navigation module 214 may control the altitude and/or direction of flight by controlling the mechanical features of the UAV that affect flight (e.g., its rudder(s), elevator(s), aileron(s), and/or the speed of its propeller(s)).

In order to navigate the UAV 200 to a target location, the navigation module 214 may implement various navigation techniques, such as map-based navigation and localization-based navigation, for instance. With map-based navigation, the UAV 200 may be provided with a map of its environment, which may then be used to navigate to a particular location on the map. With localization-based navigation, the UAV 200 may be capable of navigating in an unknown environment using localization. Localization-based navigation may involve the UAV 200 building its own map of its environment and calculating its position within the map and/or the position of objects in the environment. For example, as a UAV 200 moves throughout its environment, the UAV 200 may continuously use localization to update its map of the environment. This continuous mapping process may be referred to as simultaneous localization and mapping (SLAM). Other navigation techniques may also be utilized.

In some embodiments, the navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, the navigation module 214 and/or other components and systems of the UAV 200 may be configured for “localization” to more precisely navigate to the scene of a target location. More specifically, it may be desirable in certain situations for a UAV to be within a threshold distance of the target location where a payload 228 is being delivered by a UAV (e.g., within a few feet of the target destination). To this end, a UAV may use a two-tiered approach in which it uses a more-general location-determination technique to navigate to a general area that is associated with the target location, and then use a more-refined location-determination technique to identify and/or navigate to the target location within the general area.

For example, the UAV 200 may navigate to the general area of a target destination where a payload 228 is being delivered using waypoints and/or map-based navigation. The UAV may then switch to a mode in which it utilizes a localization process to locate and travel to a more specific location. For instance, if the UAV 200 is to deliver a payload to a user's home, the UAV 200 may need to be substantially close to the target location in order to avoid delivery of the payload to undesired areas (e.g., onto a roof, into a pool, onto a neighbor's property, etc.). However, a GPS signal may only get the UAV 200 so far (e.g., within a block of the user's home). A more precise location-determination technique may then be used to find the specific target location.

Various types of location-determination techniques may be used to accomplish localization of the target delivery location once the UAV 200 has navigated to the general area of the target delivery location. For instance, the UAV 200 may be equipped with one or more sensory systems, such as, for example, ultrasonic sensors 204, infrared sensors (not shown), and/or other sensors, which may provide input that the navigation module 214 utilizes to navigate autonomously or semi-autonomously to the specific target location.

As another example, once the UAV 200 reaches the general area of the target delivery location (or of a moving subject such as a person or their mobile device), the UAV 200 may switch to a “fly-by-wire” mode where it is controlled, at least in part, by a remote operator, who can navigate the UAV 200 to the specific target location. To this end, sensory data from the UAV 200 may be sent to the remote operator to assist them in navigating the UAV 200 to the specific location.

As yet another example, the UAV 200 may include a module that is able to signal to a passer-by for assistance in either reaching the specific target delivery location; for example, the UAV 200 may display a visual message requesting such assistance in a graphic display, play an audio message or tone through speakers to indicate the need for such assistance, among other possibilities. Such a visual or audio message might indicate that assistance is needed in delivering the UAV 200 to a particular person or a particular location, and might provide information to assist the passer-by in delivering the UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once the UAV 200 arrives at the general area of a target delivery location, the UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, the UAV 200 may be configured to navigate by “sourcing” such directional signals-in other words, by determining where the signal is strongest and navigating accordingly. As another example, a mobile device can emit a frequency, either in the human range or outside the human range, and the UAV 200 can listen for that frequency and navigate accordingly. As a related example, if the UAV 200 is listening for spoken commands, then the UAV 200 could utilize spoken statements, such as “I'm over here!” to source the specific location of the person requesting delivery of a payload.

In an alternative arrangement, a navigation module may be implemented at a remote computing device, which communicates wirelessly with the UAV 200. The remote computing device may receive data indicating the operational state of the UAV 200, sensor data from the UAV 200 that allows it to assess the environmental conditions being experienced by the UAV 200, and/or location information for the UAV 200. Provided with such information, the remote computing device may determine latitudinal and/or directional adjustments that should be made by the UAV 200 and/or may determine how the UAV 200 should adjust its mechanical features (e.g., its rudder(s), elevator(s), aileron(s), and/or the speed of its propeller(s)) in order to effectuate such movements. The remote computing system may then communicate such adjustments to the UAV 200 so it can move in the determined manner.

### C. Communication Systems

In a further aspect, the UAV 200 includes one or more communication systems 218. The communications systems 218 may include one or more wireless interfaces and/or one or more wireline interfaces, which allow the UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, a UAV 200 may include communication systems 218 that allow for both short-range communication and long-range communication. For example, the UAV 200 may be configured for short-range communications using Bluetooth and for long-range communications under a CDMA protocol. In such an embodiment, the UAV 200 may be configured to function as a “hot spot;” or in other words, as a gateway or proxy between a remote support device and one or more data networks, such as a cellular network and/or the Internet. Configured as such, the UAV 200 may facilitate data communications that the remote support device would otherwise be unable to perform by itself.

For example, the UAV 200 may provide a WiFi connection to a remote device, and serve as a proxy or gateway to a cellular service provider's data network, which the UAV might connect to under an LTE or a 3G protocol, for instance. The UAV 200 could also serve as a proxy or gateway to a high-altitude balloon network, a satellite network, or a combination of these networks, among others, which a remote device might not be able to otherwise access.

### D. Power Systems

In a further aspect, the UAV 200 may include power system(s) 220. The power system 220 may include one or more batteries for providing power to the UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

### E. Payload Delivery

The UAV 200 may employ various systems and configurations in order to transport and deliver a payload 228. In some implementations, the payload 228 of a given UAV 200 may include or take the form of a “package” designed to transport various goods to a target delivery location. For example, the UAV 200 can include a compartment, in which an item or items may be transported. Such a package may include one or more food items, purchased goods, medical items, or any other object(s) having a size and weight suitable to be transported between two locations by the UAV. In other embodiments, a payload 228 may simply be the one or more items that are being delivered (e.g., without any package housing the items).

In some embodiments, the payload 228 may be attached to the UAV and located substantially outside of the UAV during some or all of a flight by the UAV. For example, the package may be tethered or otherwise releasably attached below the UAV during flight to a target location. In some embodiments, the package may include various features that protect its contents from the environment, reduce aerodynamic drag on the system, and prevent the contents of the package from shifting during UAV flight. In other embodiments, the package may be a standard shipping package that is not specifically tailored for UAV flight.

In order to deliver the payload, the UAV may include a winch system 221 controlled by the tether control module 216 in order to lower the payload 228 to the ground while the UAV hovers above. As shown in FIG. 2, the winch system 221 may include a tether 224, and the tether 224 may be coupled to the payload 228 by a payload retriever 226. The tether 224 may be wound on a spool that is coupled to a motor 222 of the UAV. The motor 222 may take the form of a DC motor (e.g., a servo motor) that can be actively controlled by a speed controller. The tether control module 216 can control the speed controller to cause the motor 222 to rotate the spool, thereby unwinding or retracting the tether 224 and lowering or raising the payload retriever 226. In practice, the speed controller may output a desired operating rate (e.g., a desired RPM) for the spool, which may correspond to the speed at which the tether 224 and payload 228 should be lowered towards the ground. The motor 222 may then rotate the spool so that it maintains the desired operating rate.

In order to control the motor 222 via the speed controller, the tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as the motor 222 causes rotation of the spool, a rotary encoder may be used to measure this rotation. In doing so, the rotary encoder may be used to convert a rotary position to an analog or digital electronic signal used by the tether control module 216 to determine the amount of rotation of the spool from a fixed reference angle and/or to an analog or digital electronic signal that is representative of a new rotary position, among other options. Other examples are also possible.

Based on the data from the speed sensor, the tether control module 216 may determine a rotational speed of the motor 222 and/or the spool and responsively control the motor 222 (e.g., by increasing or decreasing an electrical current supplied to the motor 222) to cause the rotational speed of the motor 222 to match a desired speed. When adjusting the motor current, the magnitude of the current adjustment may be based on a proportional-integral-derivative (PID) calculation using the determined and desired speeds of the motor 222. For instance, the magnitude of the current adjustment may be based on a present difference, a past difference (based on accumulated error over time), and a future difference (based on current rates of change) between the determined and desired speeds of the spool.

In some embodiments, the tether control module 216 may vary the rate at which the tether 224 and payload 228 are lowered to the ground. For example, the speed controller may change the desired operating rate according to a variable deployment-rate profile and/or in response to other factors in order to change the rate at which the payload 228 descends toward the ground. To do so, the tether control module 216 may adjust an amount of braking or an amount of friction that is applied to the tether 224. For example, to vary the tether deployment rate, the UAV 200 may include friction pads that can apply a variable amount of pressure to the tether 224. As another example, the UAV 200 can include a motorized braking system that varies the rate at which the spool lets out the tether 224. Such a braking system may take the form of an electromechanical system in which the motor 222 operates to slow the rate at which the spool lets out the tether 224. Further, the motor 222 may vary the amount by which it adjusts the speed (e.g., the RPM) of the spool, and thus may vary the deployment rate of the tether 224. Other examples are also possible.

In some embodiments, the tether control module 216 may be configured to limit the motor current supplied to the motor 222 to a maximum value. With such a limit placed on the motor current, there may be situations where the motor 222 cannot operate at the desired operate specified by the speed controller. For instance, as discussed in more detail below, there may be situations where the speed controller specifies a desired operating rate at which the motor 222 should retract the tether 224 toward the UAV 200, but the motor current may be limited such that a large enough downward force on the tether 224 would counteract the retracting force of the motor 222 and cause the tether 224 to unwind instead. And as further discussed below, a limit on the motor current may be imposed and/or altered depending on an operational state of the UAV 200.

In some embodiments, the tether control module 216 may be configured to determine a status of the tether 224 and/or the payload 228 based on the amount of current supplied to the motor 222. For instance, if a downward force is applied to the tether 224 (e.g., if the payload 228 is attached to the tether 224 or if the tether 224 gets snagged on an object when retracting toward the UAV 200), the tether control module 216 may need to increase the motor current in order to cause the determined rotational speed of the motor 222 and/or spool to match the desired speed. Similarly, when the downward force is removed from the tether 224 (e.g., upon delivery of the payload 228 or removal of a tether snag), the tether control module 216 may need to decrease the motor current in order to cause the determined rotational speed of the motor 222 and/or spool to match the desired speed. As such, the tether control module 216 may be configured to monitor the current supplied to the motor 222. For instance, the tether control module 216 could determine the motor current based on sensor data received from a current sensor of the motor or a current sensor of the power system 220. In any case, based on the current supplied to the motor 222, determine if the payload 228 is attached to the tether 224, if someone or something is pulling on the tether 224, and/or if the payload retriever 226 is pressing against the UAV 200 after retracting the tether 224. Other examples are possible as well.

During delivery of the payload 228, the payload retriever 226 can be configured to secure the payload 228 while being lowered from the UAV by the tether 224, and can be further configured to release the payload 228 upon reaching ground level. The payload retriever 226 can then be retracted to the UAV by reeling in the tether 224 using the motor 222.

In some implementations, the payload 228 may be passively released once it is lowered to the ground. For example, a passive release mechanism may include one or more swing arms adapted to retract into and extend from a housing. An extended swing arm may form a hook on which the payload 228 may be attached. Upon lowering the release mechanism and the payload 228 to the ground via a tether, a gravitational force as well as a downward inertial force on the release mechanism may cause the payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of the payload 228 no longer forces the swing arm to extend from the housing. Retracting the swing arm into the housing may reduce the likelihood of the release mechanism snagging the payload 228 or other nearby objects when raising the release mechanism toward the UAV upon delivery of the payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, a UAV 200 could include an air-bag drop system or a parachute drop system. Alternatively, a UAV 200 carrying a payload could simply land on the ground at a delivery location. Other examples are also possible.

### IV. Illustrative UAV Deployment Systems

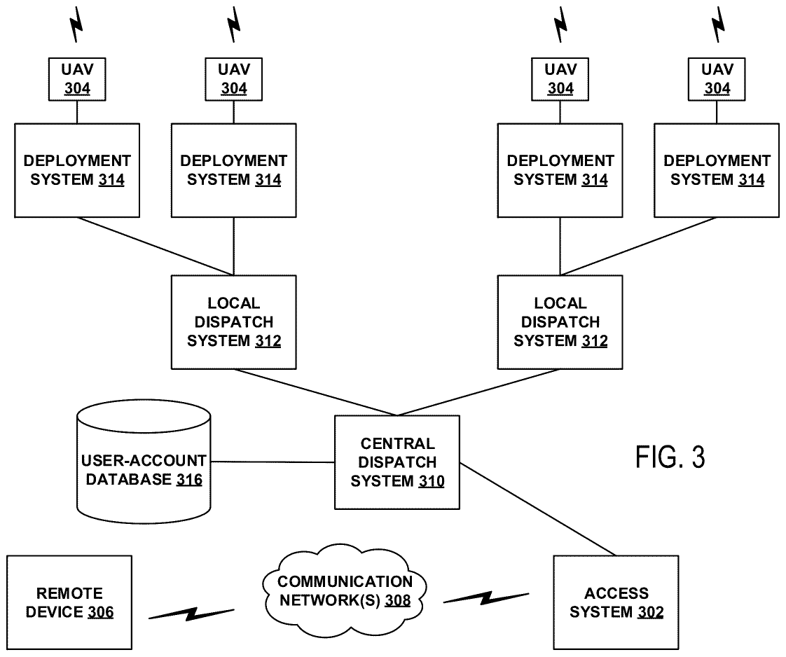

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, an access system 302 may allow for interaction with, control of, and/or utilization of a network of UAVs 304. In some embodiments, an access system 302 may be a computing system that allows for human-controlled dispatch of UA Vs 304. As such, the control system may include or otherwise provide a user interface through which a user can access and/or control the UAVs 304.

In some embodiments, dispatch of the UAVs 304 may additionally or alternatively be accomplished via one or more automated processes. For instance, the access system 302 may dispatch one of the UAVs 304 to transport a payload to a target location, and the UAV may autonomously navigate to the target location by utilizing various on-board sensors, such as a GPS receiver and/or other various navigational sensors.

Further, the access system 302 may provide for remote operation of a UAV. For instance, the access system 302 may allow an operator to control the flight of a UAV via its user interface. As a specific example, an operator may use the access system 302 to dispatch a UAV 304 to a target location. The UAV 304 may then autonomously navigate to the general area of the target location. At this point, the operator may use the access system 302 to take control of the UAV 304 and navigate the UAV to the target location (e.g., to a particular person to whom a payload is being transported). Other examples of remote operation of a UAV are also possible.

In an illustrative embodiment, the UAVs 304 may take various forms. For example, each of the UAVs 304 may be a UAV such as those illustrated in FIGS. 1A-1E. However, UAV system 300 may also utilize other types of UAVs without departing from the scope of the invention. In some implementations, all of the UAVs 304 may be of the same or a similar configuration. However, in other implementations, the UAVs 304 may include a number of different types of UAVs. For instance, the UAVs 304 may include a number of types of UAVs, with each type of UAV being configured for a different type or types of payload delivery capabilities.

The UAV system 300 may further include a remote device 306, which may take various forms. Generally, the remote device 306 may be any device through which a direct or indirect request to dispatch a UAV can be made. (Note that an indirect request may involve any communication that may be responded to by dispatching a UAV, such as requesting a package delivery). In an example embodiment, the remote device 306 may be a mobile phone, tablet computer, laptop computer, personal computer, or any network-connected computing device. Further, in some instances, the remote device 306 may not be a computing device. As an example, a standard telephone, which allows for communication via plain old telephone service (POTS), may serve as the remote device 306. Other types of remote devices are also possible.

Further, the remote device 306 may be configured to communicate with access system 302 via one or more types of communication network(s) 308. For example, the remote device 306 may communicate with the access system 302 (or a human operator of the access system 302) by communicating over a POTS network, a cellular network, and/or a data network such as the Internet. Other types of networks may also be utilized.

In some embodiments, the remote device 306 may be configured to allow a user to request delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, the UAV system 300 may receive location information (e.g., GPS coordinates, etc.) from the user's mobile phone, or any other device on the user's person, such that a UAV can navigate to the user's location (as indicated by their mobile phone).

In an illustrative arrangement, the central dispatch system 310 may be a server or group of servers, which is configured to receive dispatch messages requests and/or dispatch instructions from the access system 302. Such dispatch messages may request or instruct the central dispatch system 310 to coordinate the deployment of UA Vs to various target locations. The central dispatch system 310 may be further configured to route such requests or instructions to one or more local dispatch systems 312. To provide such functionality, the central dispatch system 310 may communicate with the access system 302 via a data network, such as the Internet or a private network that is established for communications between access systems and automated dispatch systems.

In the illustrated configuration, the central dispatch system 310 may be configured to coordinate the dispatch of UAVs 304 from a number of different local dispatch systems 312. As such, the central dispatch system 310 may keep track of which UAVs 304 are located at which local dispatch systems 312, which UAVs 304 are currently available for deployment, and/or which services or operations each of the UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when the central dispatch system 310 receives a request for UAV-related service (e.g., transport of an item) from the access system 302, the central dispatch system 310 may select a specific UAV 304 to dispatch. The central dispatch system 310 may accordingly instruct the local dispatch system 312 that is associated with the selected UAV to dispatch the selected UAV. The local dispatch system 312 may then operate its associated deployment system 314 to launch the selected UAV. In other cases, the central dispatch system 310 may forward a request for a UAV-related service to a local dispatch system 312 that is near the location where the support is requested and leave the selection of a particular UAV 304 to the local dispatch system 312.

In an example configuration, the local dispatch system 312 may be implemented as a computing system at the same location as the deployment system(s) 314 that it controls. For example, the local dispatch system 312 may be implemented by a computing system installed at a building, such as a warehouse, where the deployment system(s) 314 and UAV(s) 304 that are associated with the particular local dispatch system 312 are also located. In other embodiments, the local dispatch system 312 may be implemented at a location that is remote to its associated deployment system(s) 314 and UAV(s) 304.

Numerous variations on and alternatives to the illustrated configuration of the UAV system 300 are possible. For example, in some embodiments, a user of the remote device 306 could request delivery of a package directly from the central dispatch system 310. To do so, an application may be implemented on the remote device 306 that allows the user to provide information regarding a requested delivery, and generate and send a data message to request that the UAV system 300 provide the delivery. In such an embodiment, the central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to the central dispatch system 310, the local dispatch system(s) 312, the access system 302, and/or the deployment system(s) 314 may be combined in a single system, implemented in a more complex system, and/or redistributed among the central dispatch system 310, the local dispatch system(s) 312, the access system 302, and/or the deployment system(s) 314 in various ways.

Yet further, while each local dispatch system 312 is shown as having two associated deployment systems 314, a given local dispatch system 312 may alternatively have more or fewer associated deployment systems 314. Similarly, while the central dispatch system 310 is shown as being in communication with two local dispatch systems 312, the central dispatch system 310 may alternatively be in communication with more or fewer local dispatch systems 312.

In a further aspect, the deployment systems 314 may take various forms. In general, the deployment systems 314 may take the form of or include systems for physically launching one or more of the UAVs 304. Such launch systems may include features that provide for an automated UAV launch and/or features that allow for a human-assisted UAV launch. Further, the deployment systems 314 may each be configured to launch one particular UAV 304, or to launch multiple UAVs 304.

The deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, the deployment systems 314 and their corresponding UAVs 304 (and possibly associated local dispatch systems 312) may be strategically distributed throughout an area such as a city. For example, the deployment systems 314 may be strategically distributed such that each deployment system 314 is proximate to one or more payload pickup locations (e.g., near a restaurant, store, or warehouse). However, the deployment systems 314 (and possibly the local dispatch systems 312) may be distributed in other ways, depending upon the particular implementation. As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, the UAV system 300 may include or have access to a user-account database 316. The user-account database 316 may include data for a number of user accounts, and which are each associated with one or more persons. For a given user account, the user-account database 316 may include data related to or useful in providing UAV-related services. Typically, the user data associated with each user account is optionally provided by an associated user and/or is collected with the associated user's permission.

Further, in some embodiments, a person may be required to register for a user account with the UAV system 300, if they wish to be provided with UAV-related services by the UAVs 304 from UAV system 300. As such, the user-account database 316 may include authorization information for a given user account (e.g., a username and password), and/or other information that may be used to authorize access to a user account.

In some embodiments, a person may associate one or more of their devices with their user account, such that they can access the services of UAV system 300. For example, when a person uses an associated mobile phone, e.g., to place a call to an operator of the access system 302 or send a message requesting a UAV-related service to a dispatch system, the phone may be identified via a unique device identification number, and the call or message may then be attributed to the associated user account. Other examples are also possible.

### V. Illustrative UAV Holding Systems

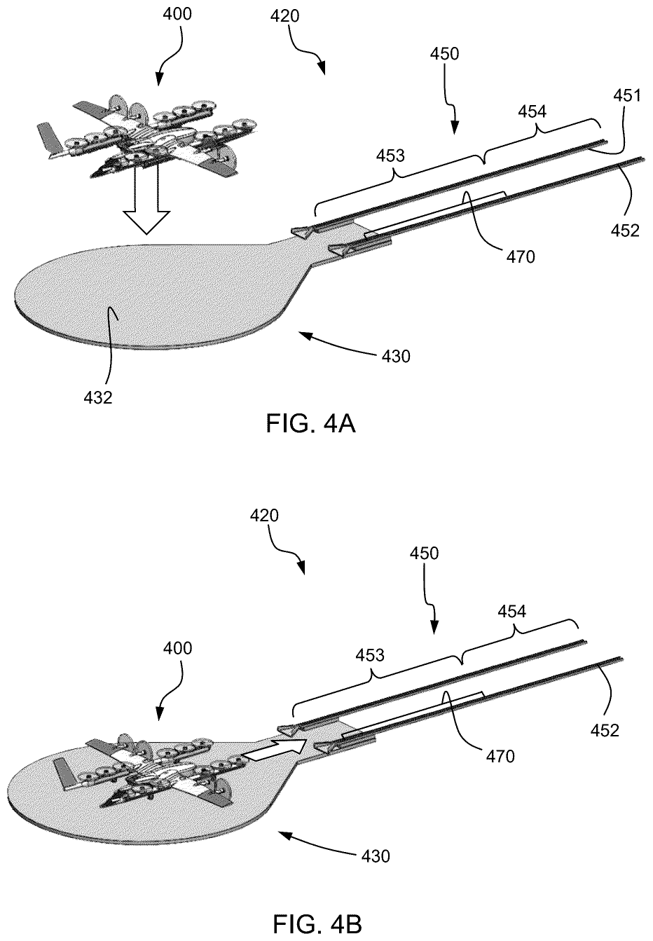

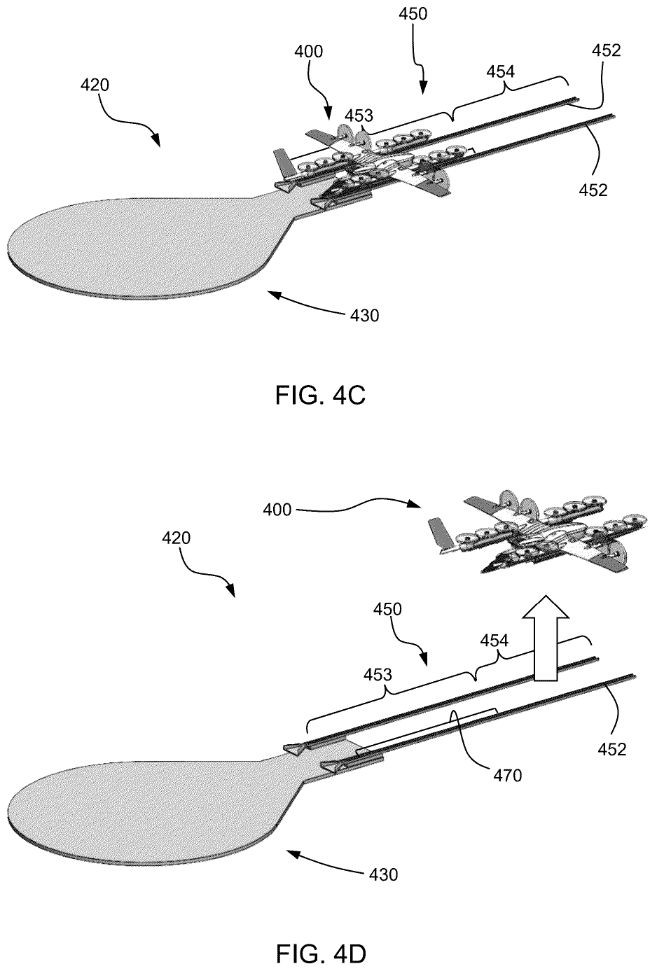

FIGS. 4A-4D illustrate a UAV holding system 420 according to an example that is configured to receive a flying UAV 400, secure the UAV 400 during a waiting period, and allow the UAV 400 to take-off when instructed, such as when deployed on a new mission. The UAV holding system 420 includes a landing pad 430 for receiving a UAV 400 and a track 450 formed by a pair of rails 451, 452 that extend from the landing pad 430. FIGS. 4A-4D illustrate several points in time of an example UAV 400 using the holding system 420. In FIG. 4A, the UAV 400 is shown descending onto a support surface 432 of the landing pad 430 of the holding system 420. As shown in FIG. 4B, after landing on the landing pad 430, the UAV 400 navigates toward and then onto the track 450. Once on the track 450, as shown in FIG. 4C, the UAV 400 may remain held securely to the holding system 420 for a desired period. Eventually, the UAV 400 may be deployed on a new mission and take off from the UAV holding system 420, as shown in FIG. 4D.

To secure the UAV 400 on the track 450, the track 450 includes a retaining section 453 that is configured to hinder unexpected removal of a UAV 400 from the track 450, such as under wind loads. UAVs of this type may be lightweight such that a gust of wind may be capable of lifting a UAV off the track if the UAV is not secured to the track. Therefore, to avoid the possibility of the UAV 400 flying off the track 450, the retaining section 453 is adapted to secure the UAV 400 on the track 450. For example, the retaining section 453 may include flanges or other structural components that hinder removal of a component of the UAV 400 while the UAV 400 is in the retaining section. Such flanges may point inward or outward to facilitate this retention. For instance, the track 450 may include a partially enclosed channel, such as a C-channel, that is configured to receive a retainer on the UAV 400. Inwardly extending flanges may limit the size of the opening to the C-channel, thereby holding the retainer in the channel. On the other hand, in other examples, the track may include outwardly extending flanges, such as on an I-beam or T-beam, and the UAV may include a bracket that hooks over the flanges to retain the UAV on the track. Other types of physical structures, such as slots, grooves or magnets may also be used to retain a UAV on the track.

In some examples, the track may also include a takeoff section from which a UAV can lift off from the track. For example, in the illustrated embodiment in FIGS. 4A-4D, the track 450 includes a takeoff section 454 past the retaining section 453. In contrast to the retaining section 453, the takeoff section 454 does not include retaining structures that hold the UAV 400 onto the track. Accordingly, when the UAV 400 is positioned within the takeoff section 454, operation of the vertical propulsion units of the UAV 400 allows the UAV 400 to lift off the track 450, as shown in FIG. 4D. As an example, where the retaining section of the track has a C-channel configuration with inwardly extending flanges adapted to hold a component of the UAV inside the channel, the takeoff section may have a U-shaped configuration with the top of the channel open, such that the component of the UAV can easily lift out of the channel during takeoff.

In other examples, the track may be configured without a takeoff section. For instance, in some examples, the track may simply have an open end and the UAV may be configured to fly horizontally off the end of the track. Alternatively, in some examples, the track may extend to a takeoff pad, opposite the landing pad, from which the UAV can take off.

In some examples, the holding system may also include a charging structure for charging one or more UAVs while they are held on the holding structure. For example, the holding system may include a charging structure that extends along the track to charge a UAV while it is positioned on the track. Such a charging structure may be formed by one or more charging components, such as electrical contacts or wireless charging units, positioned along the track. In some examples, the charging structure may be integrated into the track. In other examples, the charging structure may be independent of the track, such as a separate charging rail or separate charging units. In some examples, the charging structure may be configured to charge a UAV at the same rate regardless of where the UAV contacts the charging structure. In other examples, the charging structure may be configured to charge UA Vs at different rates based on their position on the track. For example, UAVs may be charged at a higher rate in sections of the track near the landing pad and at a slower rate in sections further from the landing pad. This may allow the UAV to charge faster when the charge level is lower and slower when the charge level is higher, which may reduce power demand and improve battery life cycle.

In the illustrated example shown in FIGS. 4A-4D, the holding system 420 also includes a charging structure 470 that is integrated into a rail 452 of the track 450. For illustration, the charging structure 470 is schematically depicted next to the rail 452. The charging structure 470 extends along the track 450 over the majority of the retaining section 453. Accordingly, while a UAV 400 is positioned in the retaining section 453, as shown in FIG. 4C, the UAV 400 may be charged using the charging structure 470. After the UAV 400 is sufficiently charged by the charging structure 470 and ready to be deployed on a new mission, it may move into the takeoff section 454 and depart the holding system 420, as shown in FIG. 4D.

While the charging structure 470 illustrated in FIGS. 4A-4D is substantially coextensive with the retaining section 453 of the track 450, in other examples, the charging structure may extend into the takeoff section of the track. Further, in some examples, the landing pad may include a charging component, in addition to or as an alternative to a charging structure that extends along the track. Further still, some example holding systems may be configured without any charging structure. Such a configuration may be useful where the holding system is used for holding UAVs during storage, loading, maintenance, or other operations without any charging. For instance, there may be scenarios where it is beneficial to have a holding system without any electrical wiring.

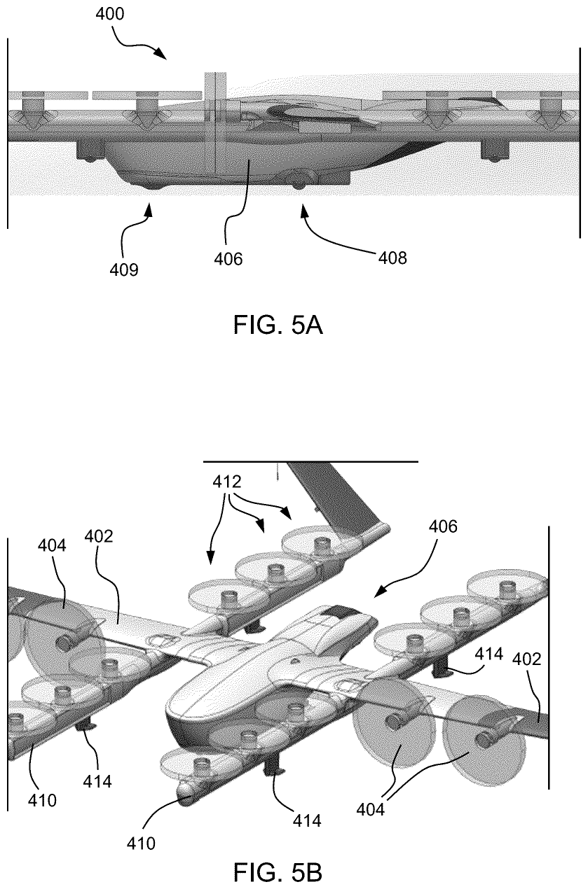

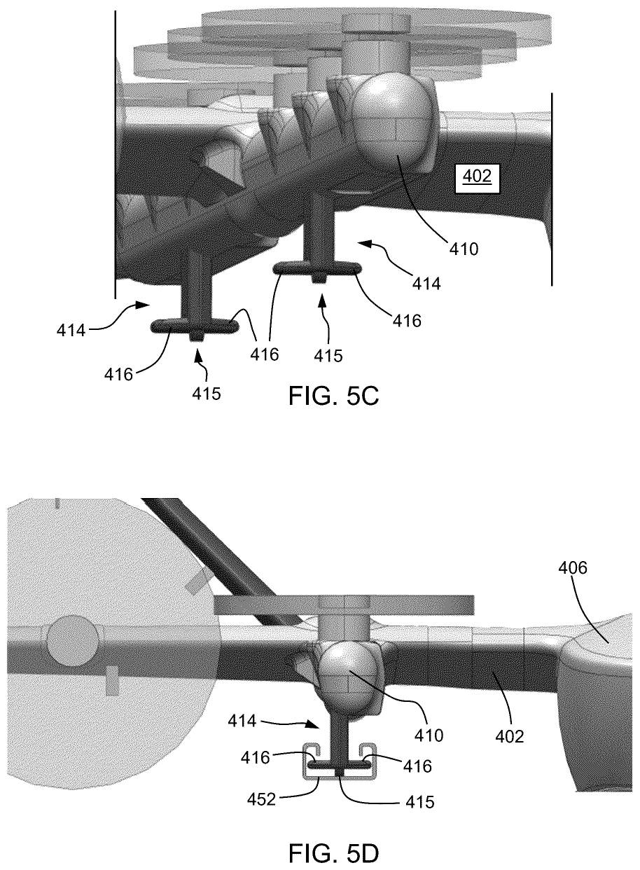

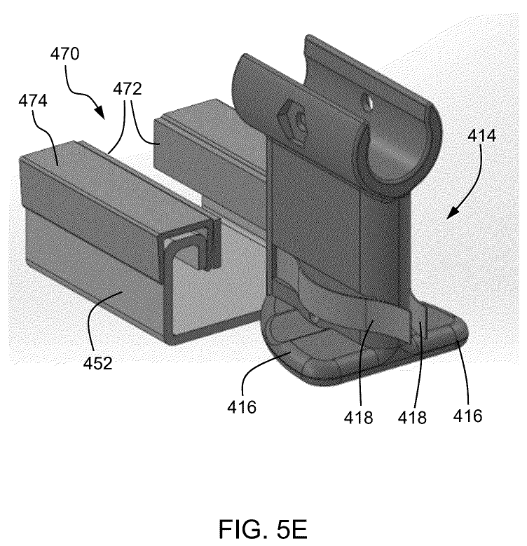

A UAV in accordance with the disclosure may take various different forms. Accordingly, a holding system according to the disclosure may have a variety of different configurations to accommodate the structure of the UAV. Likewise, as explained briefly above, the UAV may include components that are adapted to cooperate with portions of the holding system. FIGS. 5A-5E show further details of the example UAV 400 shown in FIGS. 4A-4D, illustrating specific components of UAV 400 that are adapted to cooperate with a particular example of a holding system, such as the holding system 420 shown in FIGS. 4A-4D.

FIGS. 5A and 5B illustrate components of example UAV 400, which includes a centrally positioned fuselage 406 and a pair of wings 402 extending from the fuselage 406. A boom 410 is respectively coupled to each of the wings 402 and extends longitudinally in the direction of flight. The booms 410 support a plurality of vertical propulsion units 412, and horizontal propulsion units 404 are coupled to the front edge of the wings 402. As shown in FIG. 5A, the bottom of the fuselage includes one or more wheels 408 and a skid 409. These components allow the UAV 400 to navigate around a landing pad, while the UAV 400 is supported by the fuselage 406. In other examples, the UAV may include any combination of surface navigating components, such as wheels and/or skids, attached to other parts of the UAV.

As illustrated, the example UAV 400 also includes a plurality of bogies 414 coupled to the booms 410 that are adapted to cooperate with the rails of a certain track configuration, such as an upwardly opening C-channel described above. As shown in FIGS. 5C and 5D, the bogies 414 extend down from the booms 410 and include outwardly extending flanges 416 that are configured to be secured inside the rail 452. Each of the bogies 414 also includes a wheel 415 so that the UAV 400 may roll along the track. Other examples of components that cooperate with the track may be disposed on the wing, the fuselage, or any other structure of the UAV, rather than the booms.

As shown most clearly in FIG. 5B, in this example, the bottom of the fuselage 406 is positioned substantially below the booms 410 and even below the bottom of the bogies 414. Accordingly, the track 450 of holding system 420 is elevated slightly above the surface 432 of the landing pad 430 (FIG. 4A). As a result, the support of the UAV 400 shifts from the fuselage 406 to the booms 410 as the UAV 400 moves from the landing pad 430 onto the track 450. In other examples, the track may be at the same elevation as the landing pad, and the component that supports the UAV once it is positioned on the track may be the same as the component that supports the UAV when it is on the landing pad. In other examples, the bottom of bogies may be at the same level as or may extend below the bottom of the fuselage such that the bogies may provide support for a UAV when it is on a landing pad.

In the illustrated example shown in FIGS. 4A-4D, the track 450 is formed by two rails 451, 452 that are spaced apart. The rails 451, 452 are substantially aligned with the booms (e.g., see FIG. 4C), and thus are positioned on either side of the fuselage 406, such that the fuselage 406 is not directly supported by the track 450. Additionally, in this example, the area below and between the two rails 451, 452, is exposed such that the underside of the fuselage 406 of the UAV 400 is accessible. This allows the fuselage 406 to receive or deliver payloads, and may also be useful for other operations, such as replacing batteries or components while the UAV 400 is on the track 450.

FIG. 5E illustrates a short section of an example charging structure 470 that cooperates with one of the bogies 414 of the example UAV 400. As shown, the charging structure 470 includes electrical contacts in the form of a pair of conductive strips 472 that extend along the rail 452. The conductive strips 472 are mounted on the rail 452 via an insulator 474. To cooperate with the charging structure 470, the bogie 414 also includes electrical contacts 418 that are adapted to maintain contact with the conductive strips 472 while the bogie 414 is positioned in the rail 452. The illustrated electrical contacts 418 have a spring clip configuration, however other electrical contact configurations, such as brushes or others, may be used. In the illustrated example, the bogie 414 includes electrical contacts on either side and opposing sides of the rail 452 each include a conductive strip. Accordingly, the bogie 414 may move laterally within the rail 452 without losing electrical contact with the charging structure 470. In other examples, however, the rail may include a single electrical strip. Further, in some examples, the UAV may include a simple electrical contact, such as on the bogie, while the track includes spring clips, brushes or other contact structures. Furthermore, as set forth above, other examples may include a charging structure that is entirely independent of the track.

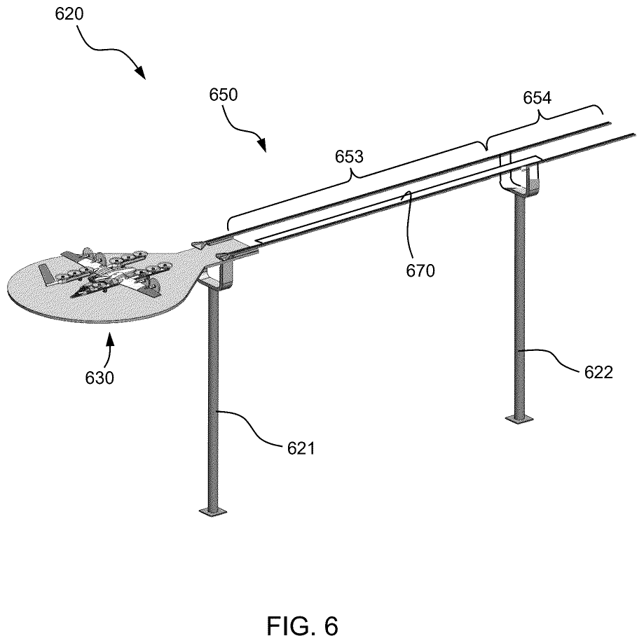

A holding system in accordance with the disclosure may be supported in various different ways. For example, the holding system may be positioned on and supported by a surface structure, such as a roof or a ground structure. Alternatively, in some examples, the holding system may be elevated. Such a holding system 620 is shown in FIG. 6. Similar to holding system 420, holding system 620 includes a landing pad 630 and a track 650 extending from the landing pad 630. The track 650 is also formed by two rails and includes a retaining section 653 adjacent to the landing pad 630 and a takeoff section 654 at an end of the track 650. The landing pad 630 and track 650 are held up by first and second support structures 621, 622. Elevating the holding system 620 may have several advantages. First, elevating the holding system 620 allows the surrounding area to be used for other purposes. For example, if the holding system 620 is positioned in a parking lot, the narrow support structures 621, 622 can be positioned between parking spaces while the landing pad 630 and track 650 is positioned above the parking spaces. This allows the holding system 620 to be positioned in the parking lot without utilizing any usable parking space. Elevating the holding system 620 also avoids the need for the UAV to fly near the ground, allowing the UAVs to be kept away from people, cars or other hazards.

In the illustrated example shown in FIG. 6, the holding system 620 is held up by two, and only two, support structures 621, 622, with the landing pad 630 and a first end of the track 650 supported by a first support structure 621 while the second end of the track 650 is supported by the second support structure 622. Supporting the holding system 620 on a pair of support structures 621, 622 may simplify installation. In an example such as the one shown in FIG. 6, where the holding system has a relatively straight configuration, any structures that support the holding system may need to be carefully aligned into a corresponding straight line in order to accommodate the holding structure. However, two support structures will inherently form a line, and therefore may avoid the need for such careful alignment, as may be needed with three or more support structures. That said, the support structures may be configured with adjustable elements, such that proper alignment is feasible. A person of skill in the art will appreciate that other arrangements of the holding system may be used, including systems that have more than two support structures and holding systems that have alignments other than relatively straight configurations.

The holding system 620 shown in FIG. 6 has an extended track 650 to accommodate multiple UAVs at the same time. In particular, the retaining section 653 of the track 650 has a sufficient length to hold multiple UAVs. Likewise, the charging structure 670 also extends along a majority of the extended track 650, allowing multiple UAVs to be charged simultaneously. This configuration allows a sequence of UAVs to land on the landing pad 630 and move along the track 650 as they are charged, until they reach the takeoff section 654 and depart for a new mission. While the example shown in FIG. 6 includes a single retaining section 653 followed by a single takeoff section 654, it is also possible for the track to include multiple takeoff and retaining sections. For instance, an example may include an intermediate takeoff section positioned between two retaining sections. With such an example, a UAV that is fully charged when it reaches the intermediate takeoff section may depart the holding system. In contrast, if the UAV needs further charging, it may pass the intermediate takeoff section and proceed into the second retaining section for further charging. Once fully charged, the UAV may backtrack into the intermediate takeoff section or proceed to another takeoff section further down the track.

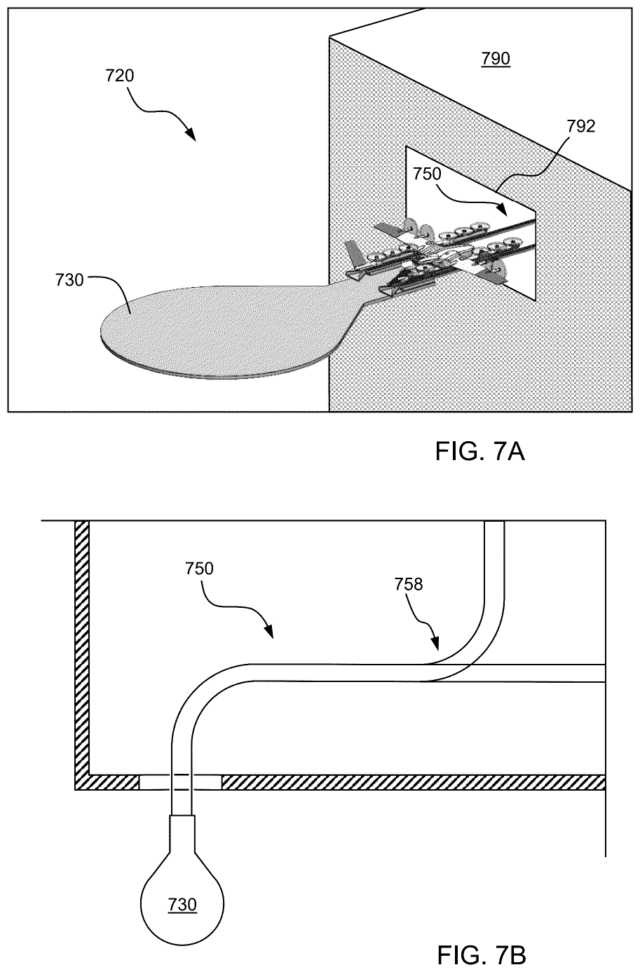

While the holding system 620 shown in FIG. 6 is configured as an independent structure for holding and charging UAVs, other examples of a holding system according to the disclosure may be integrated into other structures. For example, FIGS. 7A and 7B show a holding system 720 that is integrated into a building 790, such as a warehouse. The building 790 includes a window 792 that is appropriately sized to allow the UAV to move into the building. The holding system 720 includes a landing pad 730 that is supported outside of the building 790 near the window 792, and a track 750 that extends into the building 790. This allows a UAV to approach the holding system 720 while in flight, land on the landing pad 730 and then move into the building 790. Once inside, the UAV may be directed along the track 750 to various areas of the building, such as loading zones or maintenance areas, where other interactions with the UAV can occur. Further, as shown in FIG. 7B, the track 750 includes a switch track 758, allowing the UAV to be directed to different locations within the building. In some examples, the track may extend through another window to a takeoff area that is outside the building.

In other examples, the holding system may be integrated with other structures. For instance, in some examples, the holding system may be integrated in a mobile structure, such as a ground vehicle, for example a truck or a mobile semi-trailer. With such a configuration, the holding system can be moved to provide UAV storage, charging, and/or maintenance where needed.

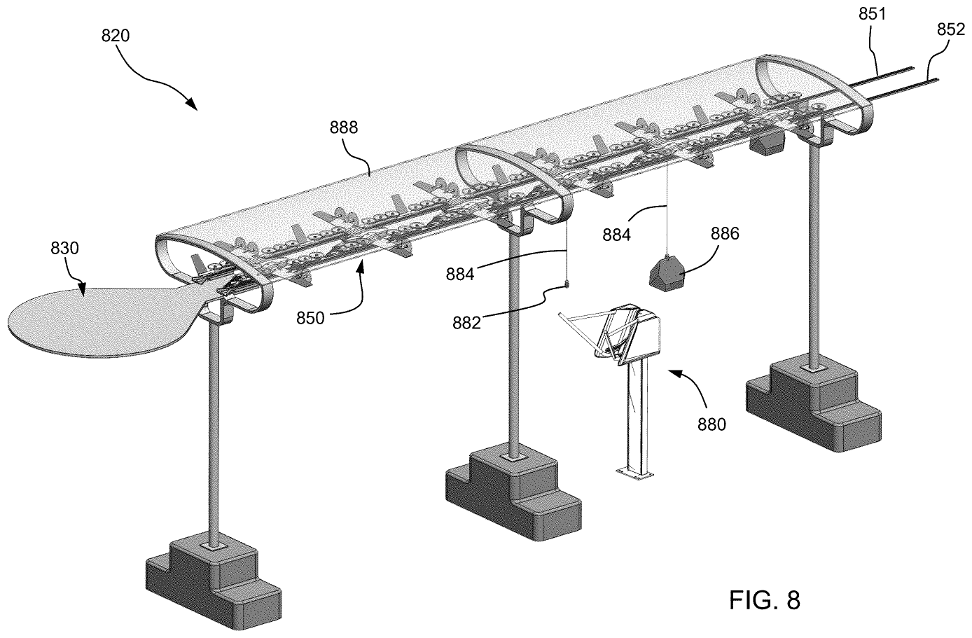

FIG. 8 illustrates a holding system 820 that includes a loading station for securing a payload to the UAV. Similar to the previously described holding systems, holding system 820 may include a landing pad 830 and a track 850 extending from the landing pad 830. The track 850 passes over a payload coupling apparatus 880 that is adapted to provide a payload 886 to the UAV. The track 850 is formed by two rails 851, 852 which are spaced apart from one another. Accordingly, a UAV that is positioned on the track 850 may retrieve and secure payloads to the underside of the fuselage.

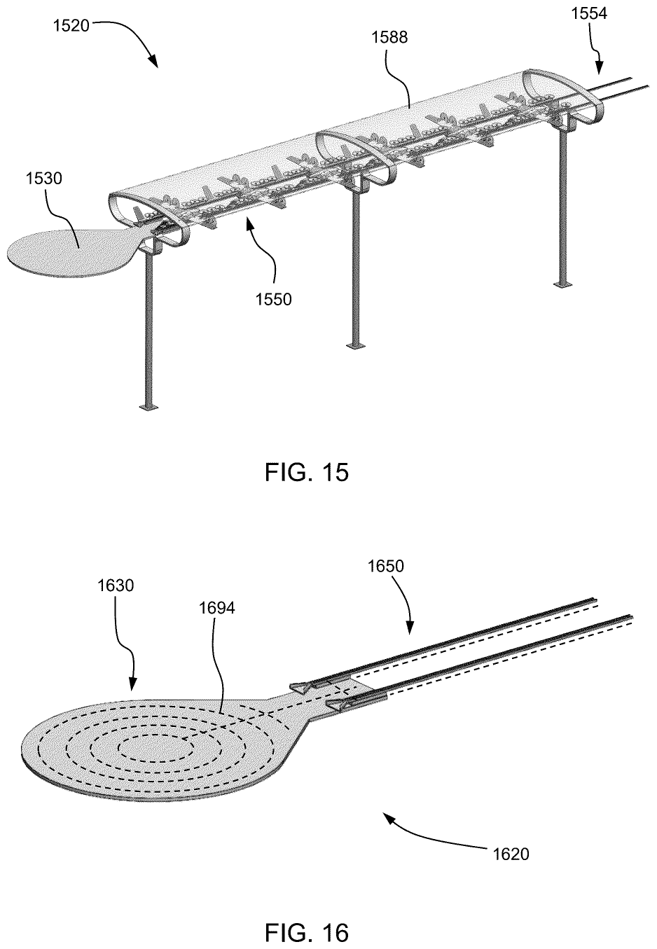

For example, FIG. 8 illustrates a payload retriever 882 on the end of a tether 884 being lowered from the UAV. Once the UAV is positioned over the payload coupling apparatus 880, the tether 884 may be retracted and pulled through the payload coupling apparatus 880. If a payload, such as payload 886, is held by the payload coupling apparatus 880, the act of pulling the retriever 882 through the payload coupling apparatus 880 can secure the payload 886 onto the retriever 882. The payload 886 may then be hoisted up to the UAV and secured to the underside of the fuselage of the UAV through the open space between the rails 851, 852. This illustrated example also includes an optional roof 888 positioned over the track 850. Advantages of such a roof is described in more detail below with respect to FIG. 15.

The foregoing example of an operational station positioned along the holding system in the form of a loading station is just one example. Other possible stations include maintenance stations, human loading stations, adjustment stations, cleaning stations, and others. The holding system may include any variety of stations that are useful in a given context. Moreover, the track may be configured to direct the UAV to the various stations where they are most conveniently located. For example, the track of the holding system may direct the UAV to several different loading stations within a warehouse in order to direct the UAV to different packing locations in the warehouse.

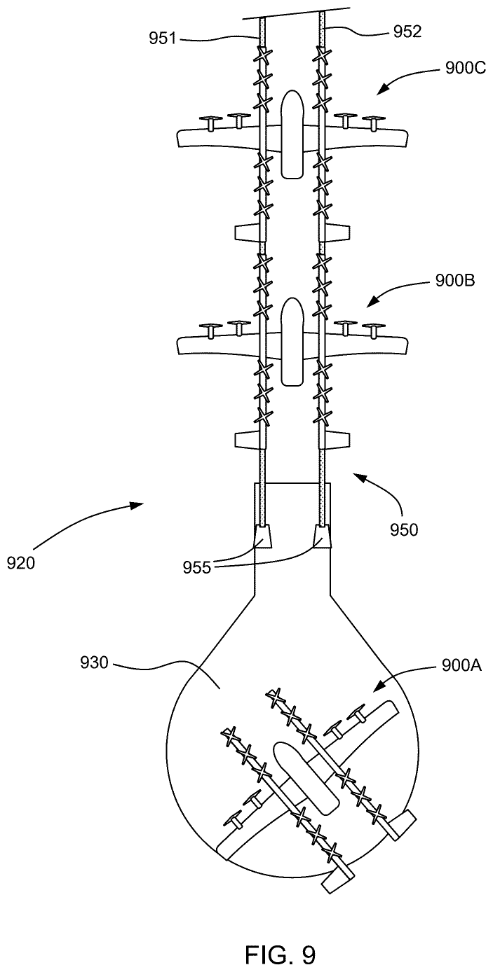

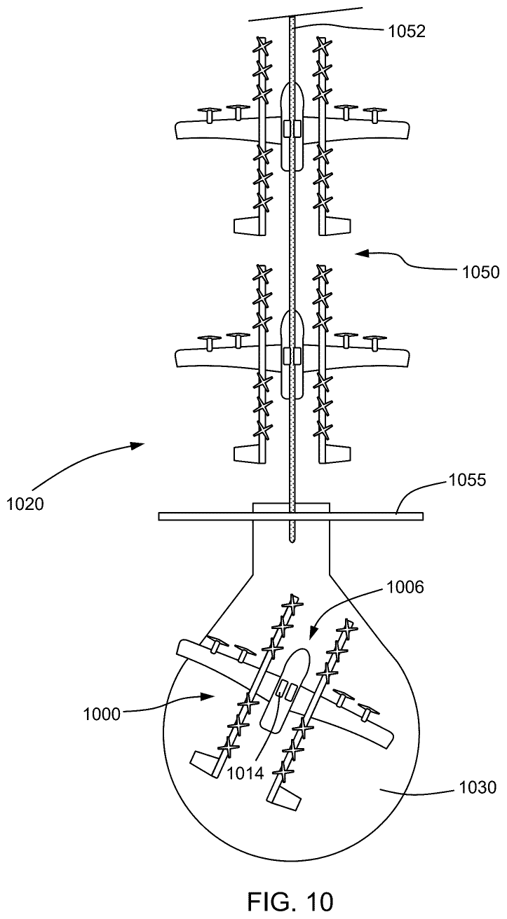

Examples of the UAV holding system may include various different configurations of tracks. FIG. 9 illustrates a holding system 920 having a track configuration similar to the holding system shown in FIGS. 4A-4D. Holding system 920 includes a track 950 that is formed by two rails 951 and 952 that extend away from the landing pad 930. The two rails 951, 952 are spaced apart to provide access to the fuselage of any UAV positioned on the track 950, as explained above. Each of the rails 951, 952 includes a funneling section 955 to guide components of the UAV onto the rails. FIG. 9 specifically shows a first UAV 900A landing on the landing pad 930, with two other UAVs 900B, 900C positioned on the track 950.

FIG. 10 illustrates another example holding system 1020. In this example the track 1050 is formed by a single rail 1052, and the UAV 1000 is configured to hang from the track 1050. To cooperate with the rail 1052, the UAV 1000 includes a clamp 1014 that is positioned on top of the fuselage 1006. After the UAV 1000 lands on the landing pad 1030, the UAV 1000 may be operated to navigate to the track 1050 such that the clamp 1014 receives the rail 1052. In the illustrated configuration, the rail 1052 is supported above the landing pad 1030 by an overhead bracket 1055. Having the UAV 1000 hang from the track 1050 allows track 1050 to be aligned with the center of the UAV 1000 while still providing access to the underside of the fuselage 1006. Of course, in other examples, the holding system may include a track with a single rail where the UAV is adapted to ride on top of the rail. Likewise, other example holding systems may include a track with more than one rail where the UAV is adapted to hang underneath the rail.

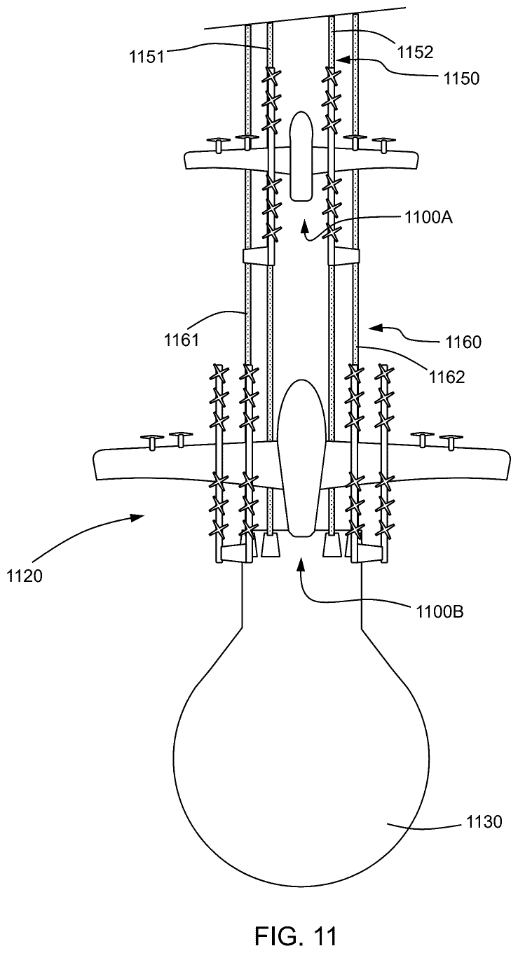

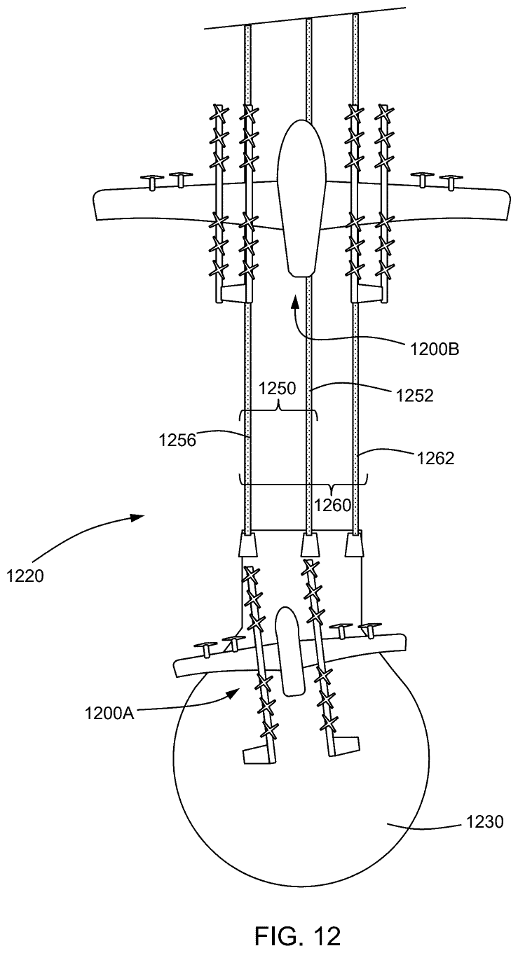

FIG. 11 illustrates an example holding system 1120 with another track configuration. Specifically, holding system 1120 includes a first inner track 1150 and a second outer track 1160 that extend in parallel from a landing pad 1130. Inner track 1150 is formed by a first rail 1151 and a second rail 1152 that are spaced apart and extend in parallel. The inner track 1150 is similar to the track shown in FIGS. 4A-4D and adapted to cooperate with UAVs having a similar configuration, such as UAV 1100A. The outer track 1160 is formed by a third rail 1161 and a fourth rail 1162 that are laterally spaced outside the first rail 1151 and second rail 1152 of the inner track 1150. The third and fourth rails 1161, 1162 also run parallel to one another, and to the rails 1151, 1152 of the inner track 1150. As shown in FIG. 11, the outer track 1160 is configured to hold the larger UAV 1100B.

The inner and outer tracks 1150, 1160 of holding system 1120 are coextensive. The term coextensive is used herein to refer to distinct tracks where UAVs positioned on the tracks follow the same path. For instance, the smaller and larger UAVs shown in FIG. 11 both follow the same path, despite the smaller UAV 1100A being positioned on the inner track 1150 while the larger UAV 1100B is positioned on the outer track 1160. The two tracks 1150, 1160 also have an open space between the rails 1151, 1161 and 1152, 1162 that aligns with the fuselages of both types of UAVs. This allows the fuselage of both types of UAVs to be accessed from under the tracks. Accordingly, the system may include various stations under the tracks 1150, 1160 that can be accessed by both types of UAVs.

FIG. 12 illustrates another example holding system 1220 with two coextensive tracks 1250, 1260. In contrast to the coextensive tracks of system 1120, the two tracks 1250, 1260 of holding system 1220 have a shared rail 1256. Thus, the two tracks 1250, 1260 are formed by three rails. Specifically, as depicted in FIG. 12, the first track 1250, which is adapted to hold smaller UAVs (e.g., 1200A) is formed by first rail 1252 on the right and shared rail 1256 on the left. Similarly, the second track 1260 is formed by third rail 1262 on the right and shared rail 1256 on the left. In the depiction shown in FIG. 12, the larger UAV 1200B is positioned on the third rail 1262 and shared rail 1256 of second track 1260, while the smaller UAV 1200A is navigating toward the first rail 1252 and shared rail 1256 of the first track 1250.

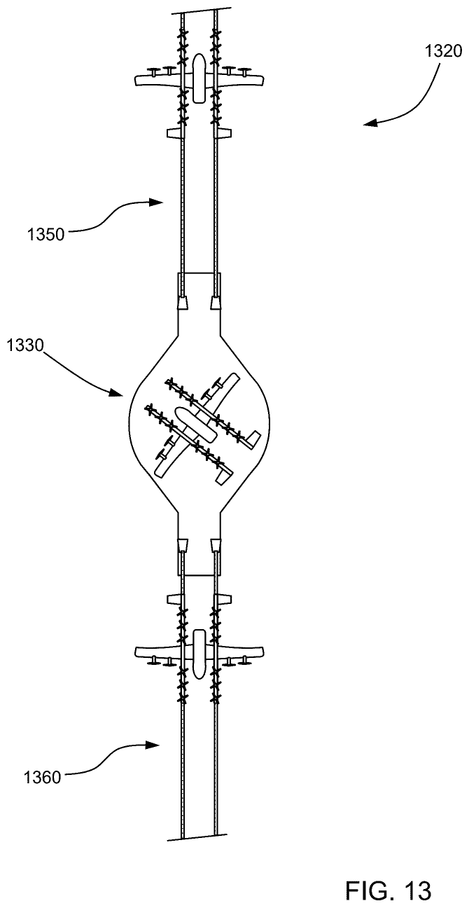

While both examples shown in FIGS. 11 and 12 have tracks that follow a common path, in other examples, the tracks may have separate paths. Such paths may initially be coextensive and then diverge, or may be entirely separate. For example, holding system 1320 shown in FIG. 13 includes a landing pad 1330, a first track 1350 extending from the landing pad 1330 in a first direction, and a second track 1360 extending from the landing pad 1330 in another direction. In this example, the two tracks 1350, 1360 extend in opposite directions, but in other examples, the tracks may extend outward at an angle to one another. Having tracks that extend from the landing pad in different directions, and are not coextensive, may provide several advantages. First, the two tracks may be operated to hold UAVs for different amounts of time. For instance, one track may be used with UAVs that are planned to be stationed on the system for a shorter amount of time, while the other track is used with UAVs that are planned to be stationed on the system for a longer amount of time. Further, the tracks may be directed to stations that provide different functions. For example, one track may extend to a loading station, while the other extends to a maintenance station. Likewise, one track may extend to a first type of loading station, while the other extends to a different loading station. Further still, the tracks may have different configurations. For instance, the two tracks may be adapted to operate with different UAVs, such that different UAVs can share a single landing pad. In addition, the tracks may have different charging capabilities, such that UAVs requiring greater charge can be directed to one track, while those requiring less charge are directed to another track. Other advantages provided by having different tracks extending from a common landing pad are also possible. It should be understood that each of the foregoing advantages may also apply to a track that departs the landing pad at a single exit point but forks into separate sections.

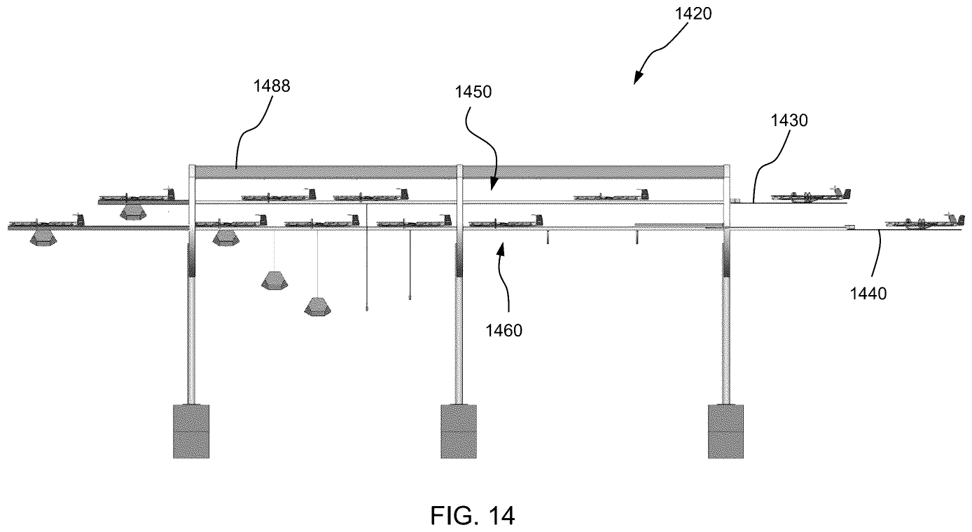

In other examples, the holding system may include independent landing pad and track pairs. For instance, FIG. 14 illustrates a holding system 1420 that includes a first landing pad 1430 coupled to a first track 1450 and a second landing pad 1440 coupled to a second track 1460. The holding system 1420 is organized so that the two tracks 1450, 1460 are positioned on top of one another. This allows the holding system 1420 to hold approximately twice as many UAVs without increasing its footprint. Further, both tracks 1450, 1460 may direct UAVs to the same operational station. To avoid interference between the two sections, the lower track 1460 is longer so that the landing pad 1440 attached to lower track 1460 extends out past the landing pad 1430 attached to the upper track 1450. Accordingly, UAVs can have direct access to the lower landing pad 1440 without needing to aerially navigate between the tracks. Likewise, the takeoff section of the lower track 1460 similarly extends out past the end of the upper track 1450, so that UAVs can takeoff from the lower track 1460 without obstruction. This illustrated example also includes an optional roof 1488 positioned above both tracks 1450, 1460. Advantages of such a roof is described in more detail below with respect to FIG. 15.

While each of the previously described illustrated track configurations are formed by rails, other examples of the holding system of the disclosure may include different types of track. For instance, some examples may include tracks having a runway configuration, a monorail configuration, or other configurations of tracks.

In some examples the holding system may include features to protect the holding system, and any UAVs positioned on the system, from environmental conditions, such as weather. For example, the holding system 1520 shown in FIG. 15, similar to those described above, includes a landing pad 1530 and a track 1550 that extends from the landing pad 1530. The track 1550 includes a takeoff section 1554 at the end opposite the landing pad 1530 where UAVs may depart from the holding system 1520. The holding system 1520 also includes a roof 1588 that is positioned over the retaining section of the track 1550. The roof 1588 helps protect the track 1550 and UAVs from sun, rain, and any debris, such as leaves, that might otherwise fall onto the track 1550 or UAVs and potentially interfere with their operation.

In some examples, such as the holding system 1520 shown in FIG. 15, the holding system may include a roof 1588 over the track 1550 while leaving the sides and underneath open. Such a configuration reduces the wind load on the overall holding system, thereby reducing structural requirements of the supports. However, the UAVs may nonetheless be protected by the wind due the track has a retaining configuration, as described in examples above.

Further, in some examples, the holding system may include heating elements to prevent snow and ice from collecting on the landing pad or track. FIG. 16 illustrates a holding system 1620 that includes a landing pad 1630 and a track 1650 extending from the landing pad 1630. Both the landing pad 1630 and the two rails of the track 1650 are provided with heating elements 1694 that are configured to keep portions of the holding system 1620 at a sufficient temperature to avoid ice or snow accumulation.

### Vi. Conclusion

The particular arrangements shown in the Figures should not be viewed as limiting. It should be understood that other implementations may include more or less of each element shown in a given Figure. Further, some of the illustrated elements may be combined or omitted. Yet further, an exemplary implementation may include elements that are not illustrated in the Figures.

Additionally, while various aspects and implementations have been disclosed herein, other aspects and implementations will be apparent to those skilled in the art. The various aspects and implementations disclosed herein are for purposes of illustration and are not intended to be limiting, with the true scope and spirit being indicated by the following claims. Other implementations may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

1. A holding and charging system for uncrewed aerial vehicles (UAVs), the system comprising:
a landing pad including a support surface for receiving a UAV;
a first track extending from the landing pad and configured to receive the UAV as it moves from the landing pad onto the first track, wherein the first track includes a first rail and a second rail spaced from the first rail to form an open space between the first rail and the second rail to allow access to an underside of the UAV through the open space when the UAV is positioned on the first track; and
a charging structure extending along the first track, the charging structure including at least one electrical contact configured to provide electrical power to a UAV positioned on the first track.

2. The holding and charging system of claim 1, wherein the first track includes a retaining section configured to secure a UAV to the first track and prevent vertical movement of the UAV away from the first track when positioned in the retaining section.

3. The holding and charging system of claim 1, wherein the first track includes a takeoff section configured to allow a UAV to move vertically off the first track.

4. The holding and charging system of claim 1, wherein each of the first rail and the second rail includes a channel configured to receive a portion of the UAV.

5. The holding and charging system of claim 4, wherein the charging structure extends along the first rail.

6. (canceled)

7. The holding and charging system of claim 1, further comprising a second track.

8. The holding and charging system of claim 7, wherein the second track is configured to receive UAVs of a different size than the first track.

9. The holding and charging system of claim 8, wherein at least a portion of the second track is coextensive with the first track.

10. The holding and charging system of claim 9, wherein the first track includes first and second rails extending from the landing pad, and wherein the second track includes at least one additional rail extending from the landing pad that is spaced from the first and second rails.

11. The holding and charging system of claim 7, further comprising a second landing pad coupled to the second track, and wherein the second track is positioned over the first track.

12. The holding and charging system of claim 7, wherein the second track extends away from the landing pad in a different direction than the first track.

13. The holding and charging system of claim 1, wherein the holding and charging structure is elevated on two support structures, the two support structures including:
a first support structure that supports the landing pad and a first end of the first track, and
a second support structure that supports a second end of the first track.

14. The holding and charging structure of claim 1, further comprising a cover extending over at least a portion of the first track.

15. The holding and charging system of claim 1, further comprising at least one heating element configured to heat the first track.

16. The holding and charging system of claim 1, wherein the landing pad and first track are supported on a ground vehicle.

17. The holding and charging system of claim 1, further comprising a payload coupling apparatus disposed under the first track.

18. The holding and charging system of claim 1, wherein a portion of the first track is positioned over landing pad.

19. The holding and charging system of claim 1, wherein the first track is elevated above the landing pad.

20. The holding and charging system of claim 1, wherein the charging structure includes a conductive strip mounted to the track that extends along a portion of the track.
